(19) United States
(12) Patent Application Publication
(10) Pub. No.: US 2026/0246407 A1
(43) Pub. Date: Aug. 20, 2026

(54) ELECTRIC DRIVE SYSTEM WITH BRUSH POLARITY FLIP CONTROL

(71) Applicant: GM GLOBAL TECHNOLOGY OPERATIONS LLC, Detroit, MI (US)

(72) Inventors: Mark R. Claywell, Birmingham, MI (US); Khorshed Mohammed Alam, Canton, MI (US)

(73) Assignee: GM GLOBAL TECHNOLOGY OPERATIONS LLC, Detroit, MI (US)

(21) Appl. No.: 19/055,158

(22) Filed: Feb. 17, 2025

(51) Int. Cl. H02P 25/12; B60K 1/00; B60L 15/00; B60L 15/20; H01R 39/38; H02K 5/14

(52) U.S. Cl. CPC H02P 25/12; B60K 1/00; B60L 15/007; B60L 15/20; H02K 5/141; H01R 39/385

(57) ABSTRACT

An electric drive system for a vehicle includes an electric motor having a stator assembly, and a rotor assembly with a rotor shaft. A base plate, a first slip ring and a second slip ring are operatively connected to an outer side of the rotor shaft. The first and second slip rings are rotatable relative to a longitudinal axis of the rotor shaft. A first set of brushes are mounted on a first side of the base plate and adapted to establish an electrical connection with the rotor assembly through contact with the first slip ring. A second set of brushes are mounted on a second side of the base plate. A controller is adapted to selectively command a polarity flip of a respective brush polarity of the brushes during operation of the electric motor, the polarity flip being electronic.

### INTRODUCTION

The disclosure relates generally to an electric drive system with an electric motor having a plurality of brushes. More particularly, the disclosure relates to brush polarity flip control of an electric motor having a plurality of brushes in an electric drive system. Brushes are generally employed to act as the electrical connection between a stationary power source and a rotating armature of an electric motor, such as a separately excited synchronous motor. In a separately excited synchronous electric motor, the current powering the rotor field windings is supplied independently from the current powering the stator windings. The electric motor relies on electromagnets on the rotor that can be adjusted by varying the excitation current. Brushes are used to deliver the excitation current to the rotor windings. However, the brushes may be subject to uneven wear over time and may have other non-uniformities.

### SUMMARY

Disclosed herein is an electric drive system for a vehicle. The system includes an electric motor having a stator assembly, and a rotor assembly with a rotor shaft. A base plate, a first slip ring and a second slip ring are operatively connected to an outer side of the rotor shaft. The first slip ring and the second slip ring are rotatable relative to a longitudinal axis of the rotor shaft. A first set of brushes are mounted on a first side of the base plate, the first set of brushes being adapted to establish an electrical connection with the rotor assembly through contact with the first slip ring. A second set of brushes are mounted on a second side of the base plate, the second set of brushes being adapted to establish the electrical connection with the rotor assembly through contact with the second slip ring. The first set of brushes and the second set of brushes define a respective brush polarity. The system includes a controller having a processor and tangible, non-transitory memory on which instructions are recorded. The controller is adapted to selectively command a polarity flip of the respective brush polarity during operation of the electric motor, the polarity flip being electronic.

The controller may be adapted to determine a first brush parameter for the first set of brushes, and a second brush parameter for the second set of brushes. The controller may be adapted to determine a difference between the first brush parameter and the second brush parameter and selectively command the polarity flip of the respective brush polarity when the difference is greater than a predefined threshold. A first mounting plate may be employed for mounting the first set of brushes on the first side of the base plate. A second mounting plate may be employed for mounting the second set of brushes on the second side of the base plate, the first mounting plate and the second mounting plate being conductive.

The controller may be adapted to obtain the first brush parameter and the second brush parameter via one or more models based in part on at least one of a revolutions per minute of the electric motor, actual rotor current and a rotor current rise rate. The first brush parameter and the second brush parameter may be tracked separately. In some embodiments, the controller is adapted to command the polarity flip of the respective brush polarity when a threshold number of rotations are achieved at one polarity, and make a switch at a subsequent cycle.

The controller may be adapted to command the polarity flip of the respective brush polarity when a noise amplitude is above a threshold noise level, the noise amplitude based in part on sensor data. The controller may be adapted to command the polarity flip of the respective brush polarity when a threshold number of vehicle key cycles are met. In some embodiments, the controller is adapted to command the polarity flip of the respective brush polarity when the rotor assembly is at a zero speed and a vehicle brake is applied. The controller may be adapted to selectively offset a stator current control angle of the electric motor based on the respective brush polarity. The stator current control angle is offset by a factor of 360 degrees divided by a number of poles in the rotor assembly.

In some embodiments, the controller is adapted to selectively apply a respective brush break-in mode during an initialization period. The respective brush break-in mode permits the first set of brushes and the second set of brushes to experience positive polarity at a plurality of rotor current levels. The controller is adapted to exit the respective brush break-in mode when at least one exit condition is met.

Disclosed herein is a vehicle with an electric motor having a stator assembly, and a rotor assembly with a rotor shaft. The electric motor includes a base plate, a first slip ring and a second slip ring operatively connected to an outer side of the rotor shaft, the first slip ring and the second slip ring being rotatable relative to a longitudinal axis of the rotor shaft. A first set of brushes are mounted on a first side of the base plate, the first set of brushes being adapted to establish an electrical connection with the rotor assembly through contact with the first slip ring. A second set of brushes are mounted on a second side of the base plate, the second set of brushes being adapted to establish the electrical connection with the rotor assembly through contact with the second slip ring. The vehicle incudes a controller having a processor and tangible, non-transitory memory on which instructions are recorded, the controller being adapted to selectively apply a respective brush break-in mode during an initialization period. The controller is adapted to exit the respective brush break-in mode when at least one exit condition is met. The respective brush break-in mode (“respective” omitted henceforth) permits the first and second set of brushes to experience positive polarity at various rotor current levels.

The brush break-in modes may include a first brush break-in mode. The controller is adapted to apply the first brush break-in mode in a direct current (DC) mode with torque generation, including maintaining a zero alternating current (AC) rotor current, maintaining a non-zero stator current and varying a DC rotor current based in part on torque demand. The brush break-in modes may include a second brush break-in mode. The controller is adapted to apply the second brush break-in mode in a DC mode without torque generation, including maintaining a zero AC rotor current, maintaining a zero stator current, and maintaining a DC rotor current at a relatively constant absolute value.

The brush break-in modes may include a third brush break-in mode. The controller is adapted to apply the third brush break-in mode with torque generation, including maintaining a baseline DC rotor current, maintaining a non-zero stator current, and maintaining an AC rotor current at a relatively constant value. The controller is adapted to selectively vary an AC frequency of the AC rotor current and control a power input to the electric motor such that a peak-to-peak value of the AC rotor current is greater than twice the baseline DC rotor current. The brush break-in modes may include a fourth brush break-in mode. The controller is adapted to apply the fourth brush break-in mode without torque generation, including maintaining a zero DC rotor current, maintaining a zero stator current, and maintaining an AC rotor current with a relatively constant peak-to-peak value.

The brush break-in modes may include a fifth brush break-in mode. The controller is adapted to apply the fifth brush break-in mode without torque generation, including maintaining a zero DC rotor current, maintaining a zero stator current. The controller is adapted to selectively vary an AC frequency of the AC rotor current and direct a thermal-limiting pattern for an AC rotor current such that a peak-to-peak value of the AC rotor current decreases over time when thermal limits are approached. The brush break-in modes may include a sixth brush break-in mode. The controller is adapted to apply the sixth brush break-in mode without torque generation, including maintaining a zero DC rotor current, maintaining a zero stator current, and directing a pulsed current pattern for an AC rotor current.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of an electric drive system having an electric machine with a first set of brushes, a second set of brushes and a controller;

FIG. 2 is a schematic fragmentary sectional view along a longitudinal axis of the electric drive system of FIG. 1;

FIG. 3A is a schematic fragmentary end view of the first set of brushes and a first slip ring;

FIG. 3B is a schematic fragmentary end view of the second set of brushes and a second slip ring;

FIG. 4 is a flowchart for a method executable by the controller of FIG. 1;

FIG. 5 is a flowchart for another method executable by the controller of FIG. 1; and

FIGS. 6 through 11 illustrate various examples of current wave forms employable in the electric drive system of FIG. 1, with the horizontal axes depicting time, and the vertical axes depicting rotor current.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

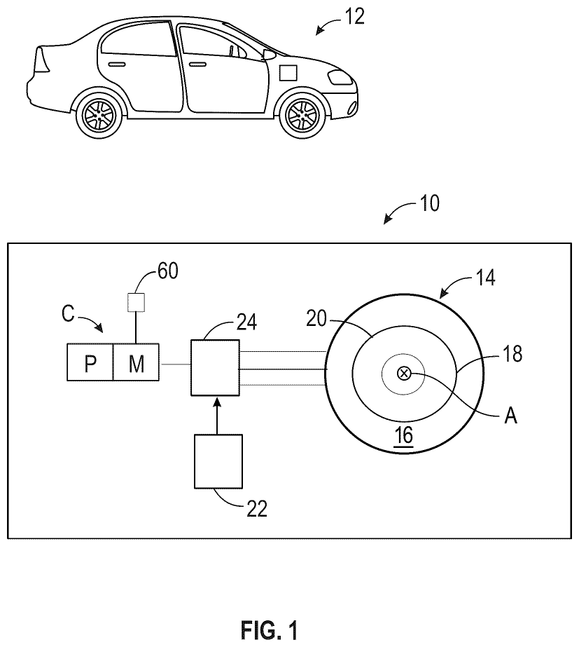

Referring to the drawings, wherein like reference numbers refer to like components, FIG. 1 is a schematic fragmentary diagram of an electric drive system 10, which may be part of a vehicle 12. The vehicle 12 may be a mobile platform, such as, but not limited to, a passenger car, sport utility vehicle, light truck, heavy duty vehicle, ATV, minivan, bus, transit vehicle, bicycle, robot, farm implement, sports-related equipment, boat, plane, train or other device. The vehicle 12 may be partially or fully electric. The vehicle 12 may take many different forms and include multiple and/or alternate components and facilities.

The electric drive system 10 includes an electric motor/generator, referred to herein as electric motor 14, configured to generate torque. In some embodiments, the electric motor is a separately excited synchronous motor. Referring to FIG. 1, the electric motor 14 includes a stator assembly 16 positioned at least partially around a rotor assembly 18 having a rotor shaft 20. The electric motor 14 may be electrically coupled to one or more power sources 22 through a power converter or inverter 24. The power sources 22 may include a direct current (DC) power source such as a battery. For simplicity, various components of the electric motor 14 are omitted in FIG. 1.

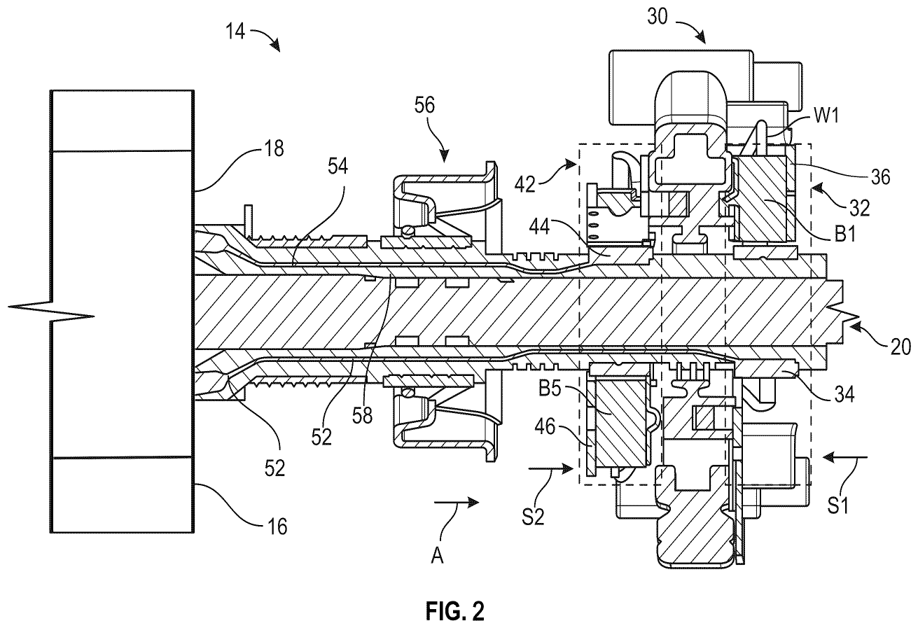

FIG. 2 is a schematic fragmentary sectional view along a longitudinal axis A of the electric motor 14. FIG. 2 illustrates a base plate 30 operatively connected to an outer side of the rotor shaft having a first side S1 and a second side S2. As described below, each side of the base plate 30 features a conductive mounting plate that carries one or more brushes and serves as an input for electrical current. The base plate 30 may be non-conductive.

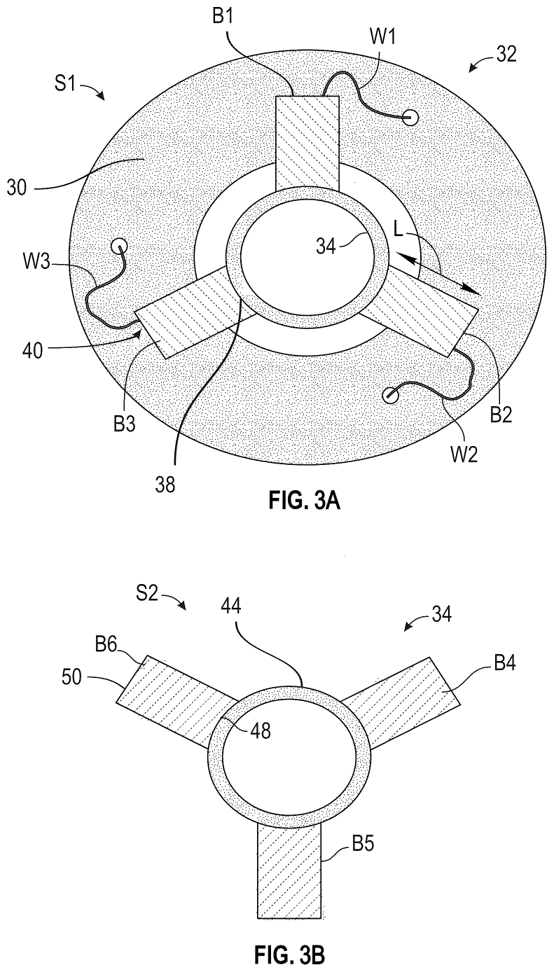

Referring to FIG. 2, a first set of brushes 32 are mounted on a first side S1 of the base plate 30 via a first mounting plate 36. The first set of brushes 32 are adapted to establish an electrical connection with the rotor through contact with a first slip ring 34. FIG. 3A provides a schematic, fragmentary end view of the first set of brushes 32 having brushes B1, B2, and B3, as seen from the first side S1 of FIG. 2. Each brush B1, B2, and B3 is connected through wires W1, W2, and W3 to the first mounting plate 36. Each brush B1, B2, and B3 has a respective first end 38 and a respective second end 40.

Referring to FIG. 2, a second set of brushes 42 are mounted on the second side S2 of the base plate 30 via a second mounting plate 46. The mounting plates 36, 46 may be configured with the same geometry on both sides. FIG. 3B presents a schematic, fragmentary end view of the second set of brushes 42 having brushes B4, B5, and B6, which are connected to the rotor assembly 18 via wires (not shown) as seen from the second side S2 of FIG. 2. The second set of brushes 42 are adapted to establish an electrical connection with the rotor through contact with the second slip ring 44. Referring to FIG. 3B, each brush has a respective first end 48 and a respective second end 50. The brushes B1 through to B6 may be free to move in the radial direction. Springs may be employed (not shown) to push the respective brushes into the corresponding slip ring 34, 44. The brushes B1 through to B6 may be equally spaced and staggered in a circumferential direction. While this example shows six brushes in total (three on each side), it is understood that the number of brushes may vary depending on the application.

The rotor windings of the rotor assembly 18 require electric current to create a magnetic field. The first and second slip rings 34, 44 may be continuous conducting rings mounted on the rotor shaft 20 and are rotatable around a longitudinal axis of the rotor shaft 20. The brushes are stationary and make sliding contact with the rotating slip rings 34, 44, creating a pathway for current to flow between the rotating part and the stationary part of the electric motor 14. Referring to FIG. 2, first busbar 52 and second busbar 54 connect the first slip ring 34 and the second slip ring 44 to the rotor assembly 18. The electric motor 14 may include a shaft seal assembly 56 and an over-molding or molded assembly 58 applied to the rotor shaft 20, shown in FIG. 2.

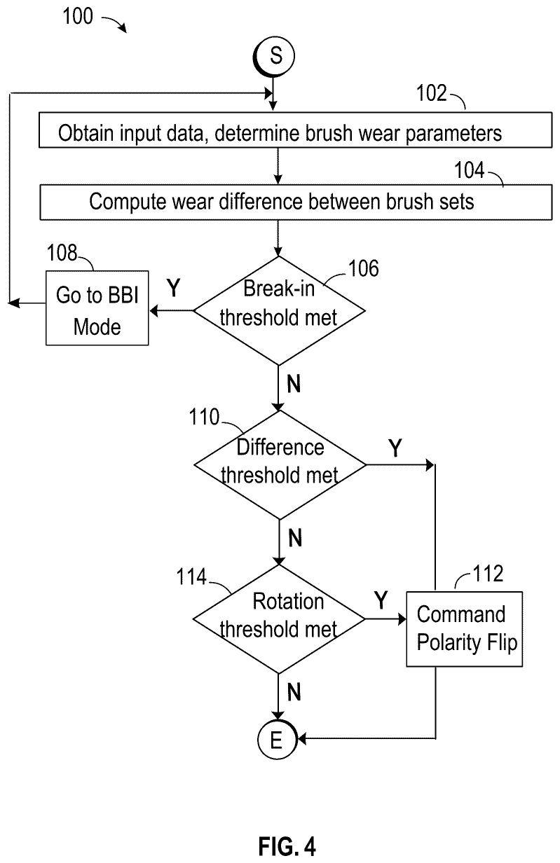

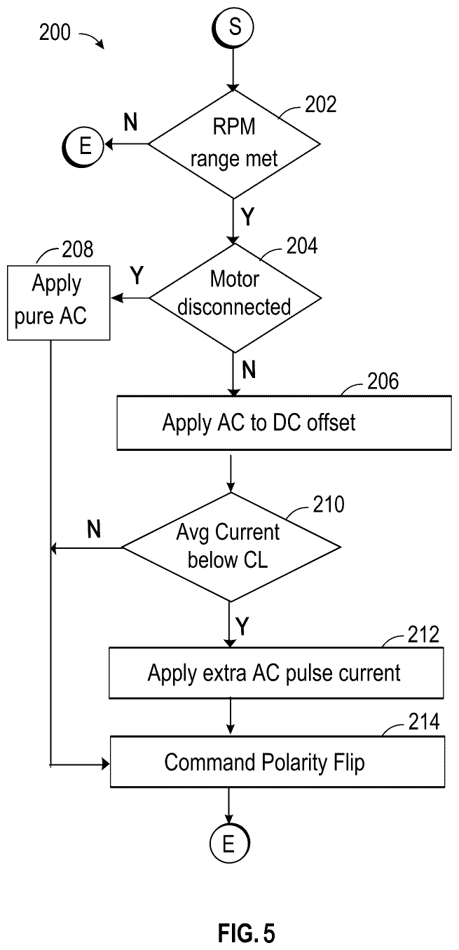

Referring to FIG. 1, the electric drive system 10 includes a controller C having at least one processor P and at least one memory M (or non-transitory, tangible computer readable storage medium) on which instructions are recorded for executing module 100 and/or module 200 for controlling operation of the electric motor 14. Module 100 is described below with reference to FIG. 4. Module 200 is described below with reference to FIG. 5. The memory M can store executable instruction sets, and the processor P can execute the instruction sets stored in the memory M.

The controller C of FIG. 1 is specifically programmed to execute the blocks of the module 100 and/or module 200 (and may receive inputs from one or more sensors 60. The sensor data may include rotor noise, brush dimensions (length and width), surface irregularities in respective contact surfaces where the first and second set of brushes 32, 42 contact the first and second slip rings 34, 44. As an alternative to physical sensors, virtual software replacements may be used. Additionally, controller C may be programmed to determine the respective physical factors by inputting the respective signals into a model or other estimation technique available to those skilled in the art.

As described below, the controller C is adapted to selectively command a brush polarity flip of the first and second set of brushes 32, 42 based in part on one or more brush parameters. The polarity flip control is accomplished through electronic switches as opposed to mechanical brush reversal. Brush polarity refers to the direction of the electrical current flowing through the brushes. The brushes on the same mounting plate 36, 46 represent one polarity—either positive or negative. In other words, each brush set 32, 42 is connected to one polarity of the rotor supply current. Positive brush polarity generally indicates that the brushes are positive, and the corresponding slip ring is negative. Negative brush polarity generally indicates that the brushes are negative, and the corresponding slip ring is positive. In some embodiments, the position of the stator magnetic field relative to the rotor magnetic field is kept constant when the rotor polarity is flipped. This is achieved through indexed rotation of the stator magnetic field when the rotor polarity is flipped, or selectively offsetting a stator current control angle. The control angle represents the angular displacement between the magnetic field created by the stator and the magnetic field position of the rotor. For example, the controller C may be adapted to move the stator magnetic field by one rotor pole spacing to keep the local stator field the same relative to the rotor field. In other embodiments, the stator magnetic field may be kept stationary when the rotor polarity was flipped (i.e., the rotor magnetic field rotates). In this case, the position of the stator magnetic field relative to the rotor magnetic field changes when the rotor polarity is flipped, altering the torque generated.

The electric drive system 10 may employ brush polarity control for various reasons, such as maximum brush life (even wear) and/or brush break-in or initialization. The polarity flip demand may be determined based on several conditions. The controller C may be adapted to determine a difference between the first brush parameter and the second brush parameter and selectively command the brush polarity flip of the first set of brushes 32 and the second set of brushes 42 when the difference is greater than a predefined threshold.

Referring now to FIG. 4, a flowchart of an example module 100 is shown. Module 100 may be embodied as computer-readable code or instructions stored on and at least partially executable by the controller C. Module 100 need not be applied in the specific order recited herein. Furthermore, it is to be understood that some blocks or steps may be eliminated.

Beginning at block 102, the controller C is adapted to obtain input data and determine a first brush parameter for the first set of brushes 32, and a second brush parameter for the second set of brushes 42 based on the input data. In some embodiments, brush wear is monitored through sensor data. For example, sensed gross brush wear may be determined by sensors 60 that detect and output the brush wear status. The first brush parameter may be based in part on an average length L of the first set of brushes 32 relative to a predefined minimum length (e.g., a length supplied by a manufacturer). Similarly, the second brush parameter may be based on an average length L of the second set of brushes 42 relative to the predefined minimum length. The parameters may be tracked and integrated separately for each side of the plurality of brushes, with the controller C storing brush wear values in memory.

In some embodiments, brush wear is monitored through modeled methods. The first brush parameter and the second brush parameter may be obtained via one or more models based in part on at least one of a revolutions per minute (RPM) of the electric motor, actual rotor current and a rotor current rise rate. Similar to the sensed method, the wear may be tracked separately for each side of the brushes with the controller C storing the corresponding values. The brush wear model may also incorporate additional factors such as the distance from the bearing as a weighting factor, ambient temperature, and drive unit oil temperature. In some embodiments, the rotor current rise rate is also used as an input parameter to the brush wear model to predict differences in radius-of-curvature wear, while both the rotor current rise rate and actual rotor current may be used as input parameters to predicting variations in radius-of-curvature wear. Additionally, a lookup table and/or machine learning algorithms (e.g. a neural network) may be employed to determine brush wear at each step based on these input parameters.

Advancing to block 104, the module 100 includes determining a difference between the first and second brush parameters. In some embodiments, the brush wear parameter incorporates surface irregularities, including the microscopic peaks and valleys on the contacting or interfacing surfaces of the respective brush and slip ring. These surface irregularities affect the electrical contact and wear characteristics. Fine surface brush wear, including notches and surface pits, may be detected using frequency-based noise measurements of a DC rotor current supply. In some embodiments, noise amplitude is analyzed with a notch filter applied at the inverter switch frequency, at the rotor rotational order for scratch detection, and at rotor sub-harmonic frequencies for brush jumping detection. The controller C may be adapted to store noise values for each polarity state, to update and learn noise characteristics per polarity. This enables the assignment of wear weighting to one side of the brush versus the other, improving the accuracy of brush wear predictions.

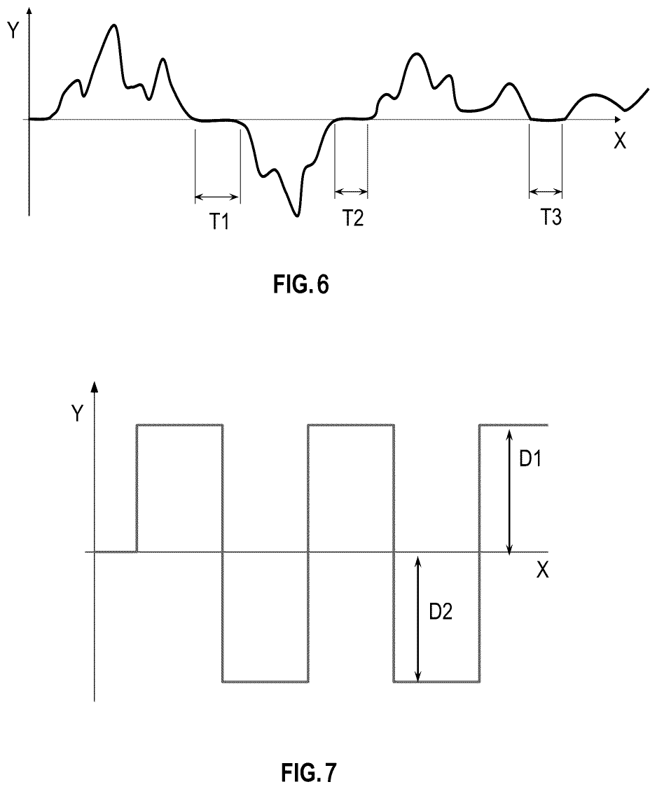

Proceeding to block 106, the controller C is adapted to determine if a break-in threshold is met. If so (Block 106=YES), the module 100 advances to block 108 to proceed to the brush break in modes (described with reference to FIGS. 6-11 below) and the module 100 is ended.

If not (Block 106=NO), the module 100 advances to block 110 to determine if a difference threshold has been met. If so (Block 110=YES), the module 100 advances to block 112 to command a polarity flip. If not (Block 110=NO), the module 100 advances to block 114 to determine if a rotation threshold has been. If so (Block 114=YES), the module 100 advances to block 112 to command a polarity flip. If not (Block 114=NO), the module 100 is ended.

In some embodiments, the controller C is adapted to command a polarity switch when a specified number of rotations is reached at one polarity, in which case the controller C is adapted to switch polarity at the next cycle regardless of whether the brush wear is modeled or sensed. Another condition that may trigger a polarity flip is the presence of sensed electrical brush or slip-ring noise, obtained through sensor data. Additionally, polarity changes may be based on a vehicle key cycles or a multiple thereof. For example, the controller C may be adapted to command a polarity switch each time the rotor assembly reaches zero speed (RPM=0) while the vehicle brake is applied. A combination of these factors may also determine when the polarity flip command should be executed by the controller C.

When the control demand for polarity change is received by the controller C, the actual brush polarity switch may be executed based on specific triggers. The switch may occur at the next vehicle key cycle, at the next zero RPM point, or at the next zero RPM point when the vehicle brake is applied. If the electric drive system 10 includes a mechanical disconnect option, the switch may also be executed after the rotor assembly 18 is mechanically disconnected.

In some embodiments, the controller C is adapted to create a brush polarity state variable to track whether the electric motor 14 is in the baseline polarity state or the flipped polarity state. This state affects the stator current control angle. In the baseline polarity state, the stator current control angle remains in its normal configuration. However, in the flipped polarity state, the reference angle of the rotor is offset relative to the position sensor to accommodate the shift in polarity by one pole. As a result, the stator current control angle is adjusted by dividing 360 degrees by the number of poles in the rotor assembly.

The system 10 has the technical advantage of eliminating the need for using two different brush materials. Reversing the polarity between the first set of brushes 32 and the second set of brushes 42 allows even wear of each brush set. This enables longer brush life since the brushes will wear at a uniform rate. This control system may be applied to both wet and dry brush systems.

As noted above, the controller C may be adapted to support multiple brush break-in modes during the initialization process or when the brushes are newly installed. Different modes of rotor current application may be employed to help evenly and rapidly wear-in new brushes, including at relatively low rotor current levels. This allows the first and second set of brushes 32, 42 on both the first side S1 and the second side S2 to experience positive polarity at various current levels (depending on usage) during break-in.

The controller C may be adapted to exit the brush break-in mode based on a plurality of parameters being above or below a respective threshold. For example, the parameters may include vehicle miles, total rotor rotations, brush noise, wear measurements, electrical path resistance between rotor, brush, and corresponding slip ring, or the integral of RPM multiplied by rotor current. It is understood that the controller C may employ a combination of these parameters or additional metrics to determine when to exit the brush break-in mode. Re-entry into brush break-in mode may occur through various triggers. For example, the trigger may include a user command to the controller C, detection of new brushes via length sensing, or identification of brush wear through methods such as frequency noise analysis. Using brush break-in modes enables the brushes to be ready for a higher current rating sooner in its life and does not incur brush surface burnishing or burning.

The brush break-in modes may operate in either open or closed loop configurations. The open loop controller C follows a predetermined schedule of polarity flips based on factors such as rotor RPM, rotation count, and current draw. These flips occur at key cycles or when the rotor speed reaches zero, with or without brake application. In contrast, closed loop control manages polarity changes based on brush electrical noise or measured wear rates. In some embodiments of the brush break-in modes where AC current is employed, the controller C may be adapted to vary the AC frequency. The AC frequency may be affected by the RPM of the rotor, rotor current, the time that has elapsed from the start of the brush break in mode, temperature and other factors. For example, the controller C may be adapted to increase the AC frequency to reduce noise in the event of “scratched” or “noisy” slip ring conditions.

Referring now to FIGS. 6 through 11, various examples of brush break-in modes employable in the electric drive system 10 are shown. Current wave forms are shown in FIGS. 6-11, with each horizontal axis X depicting time, and each vertical axis Y depicting rotor current. It is understood that the brush break-in modes described below are intended as examples and other examples may be employed.

FIG. 6 illustrates a first brush break-in mode in a DC mode with torque generation, where the motor actively generates torque while maintaining specific current patterns. The stator current remains active (ON) at non-zero levels. Boththe DC rotor current and the stator current may vary continuously according to operational or torque demand. The controller C is adapted to maintain zero AC rotor current throughout this mode, implementing frequent polarity flips to ensure proper brush conditioning. This configuration allows for normal motor operation while simultaneously executing the brush break-in process. The time bands T1, T2 in FIG. 6 each illustrates a time band of zero current and zero speed or a key off cycle. In the third time band T3, the polarity may not be flipped if conditions are not met, even if the rotor current is dropped to zero.

FIG. 7 illustrates a second brush break-in mode in a DC mode without torque generation. Here, the stator current remains completely off at zero current, while a constant DC rotor current is maintained at a relatively constant absolute value indicated by D1 and D2 (e.g., 4 Amperes). No AC rotor current is applied during this mode. Since the stator current is disabled, the controller C may implement frequent polarity flips of the DC rotor current. In other words, when operating without torque production, typically in secondary drive applications, the controller C applies rate-limited DC rotor current while maintaining zero stator current. This current is capped at a specified amperage and operates under reduced thermal limits during break-in.

FIG. 8 illustrates a third brush break-in mode with torque generation, with the electric motor 14 operating with multiple current components. AC mode operation offers additional flexibility for the electric drive system 10. When driving with torque, the AC mode combines DC rotor current with an AC component to achieve higher peak currents and ensure each brush experiences positive polarity over time. The stator assembly 16 remains energized (ON) with non-zero current, while a baseline DC rotor current is maintained at a moderate level, such as 7 amperes. Simultaneously, an AC rotor current (indicated in FIG. 8 as F1) is applied with a larger peak-to-peak amplitude, which exceeds the DC component (shown in FIG. 8 as F2). In one example the AC rotor current has a value of about 8 Amperes. In some embodiments, the AC peak-to-peak value is set to be greater than twice the DC component to achieve effective polarity switching at the brushes. Since the electric motor 14 is actively generating torque during this mode, the DC component dynamically adjusts based on the torque demands of the vehicle 12, while the AC component can maintain either constant or varying amplitude as needed for brush conditioning. Polarity flipping continues but may occur less frequently than a pure DC mode.

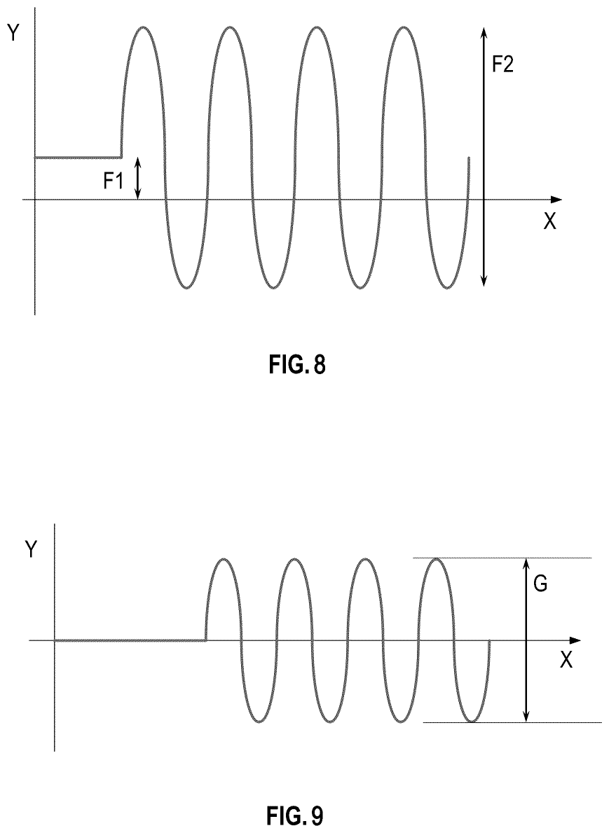

FIG. 9 illustrates a fourth brush break-in mode with AC, continuous operation and zero torque generation. The controller C maintains zero stator current while applying either constant or pulsed AC current to the rotor. No DC rotor current is applied. Instead, the controller C may direct a pure AC rotor current with a constant peak-to-peak value, indicated as G in FIG. 9. Here, the constant current stays below continuous limits, while pulsed operation uses short bursts at higher currents within peak limits. The thermal model dynamically adjusts maximum current thresholds. In some embodiments, the current limits are governed by fixed amperage caps and/or specialized thermal limits during break-in mode.

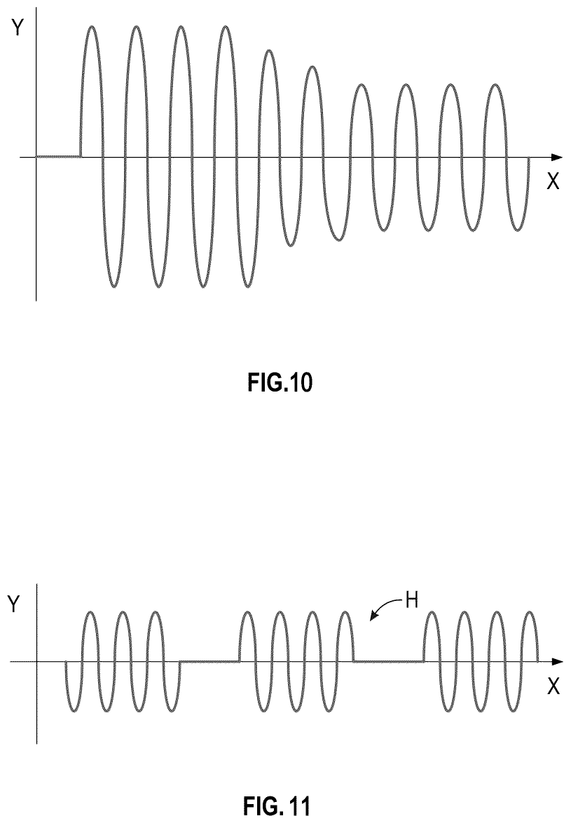

FIG. 10 illustrates a fifth brush break-in mode with continuous but declining AC current and no torque generation. Here the controller C may be adapted to operate with a dynamic current profile while maintaining zero mechanical output. The stator remains deactivated (OFF) with no current, and no DC rotor current is applied. Instead, the system initially applies a continuous AC rotor current that actively responds to thermal conditions. When thermal limits are approached, the peak-to-peak AC current value gradually decreases over time, creating a self-regulating pulsed or burst pattern. This automatic reduction in AC current amplitude (occurring as pulsed or burst AC current) ensures thermal protection while maintaining the brush conditioning process, though at a reduced intensity until thermal conditions improve.

FIG. 11 illustrates a sixth brush break-in AC mode with burst operation and no torque generation. Here the controller C may be adapted to direct a distinctive pulsed current pattern while maintaining zero mechanical output. The stator current is zero (OFF), and no DC rotor current is applied. Instead, the controller C is adapted to implement a cyclical pattern where the AC rotor current rapidly rises to a specified peak value, then returns to zero before repeating the cycle. This burst pattern of AC current provides intermittent but intense brush conditioning periods while allowing for thermal recovery during the zero-current intervals (indicated as H in FIG. 11), making it an effective approach for brush break-in without continuous current stress.

Referring now to FIG. 5, a flowchart of an example module 200 is shown. Module 200 may be embodied as computer-readable code or instructions stored on and at least partially executable by the controller C. Module 200 need not be applied in the specific order recited herein. Furthermore, it is to be understood that some blocks or steps may be eliminated.

Beginning at block 202, the controller C is adapted to determine if an RPM range for the electric motor 14 has been met. If so (Block 202=YES), the module 200 advances to block 204 to determine if the electric motor 14 is disconnected. If not (Block 202=NO), the module 200 is ended. If the electric motor 14 is disconnected (Block 204=YES), the module 200 advances to block 208 to apply pure AC to the electric motor 14. From block 208, the module 200 advances to block 214 where the controller C is adapted to command a polarity flip.

If the electric motor 14 is not disconnected (Block 204=NO), the module 200 advances to block 206 to apply AC current to the DC offset in the electric motor 14. Proceeding from block 206 to block 210, the controller C is adapted to determine if the average current to the electric motor 14 is below a predefined current level. If so (Block 210=YES), the module 200 advances to block 212 to apply additional AC pulse current. If not (Block 210=NO), the module 200 advances to block 214. From block 212, the module 200 also advances to block 214 where the controller C is adapted to command a polarity flip and the module 200 is ended.

It is understood that the module 100 and/or module 200 may be executed in real-time, continuously, sporadically and/or at regular intervals during normal and ongoing operation of the vehicle 12. The controller C includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file storage system, an application database in a proprietary format, a relational database management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description, are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electric drive system for a vehicle, comprising:
an electric motor having a stator assembly, and a rotor assembly with a rotor shaft;
a base plate, a first slip ring and a second slip ring operatively connected to an outer side of the rotor shaft, the first slip ring and the second slip ring being rotatable relative to a longitudinal axis of the rotor shaft;
a first set of brushes mounted on a first side of the base plate, the first set of brushes being adapted to establish an electrical connection with the rotor assembly through contact with the first slip ring;
a second set of brushes mounted on a second side of the base plate, the second set of brushes being adapted to establish the electrical connection with the rotor assembly through contact with the second slip ring;
wherein the first set of brushes and the second set of brushes define a respective brush polarity; and
a controller having a processor and tangible, non-transitory memory on which instructions are recorded, the controller being adapted to selectively command a polarity flip of the respective brush polarity during operation of the electric motor, the polarity flip being electronic.

2. The electric drive system of claim 1, further comprising:
a first mounting plate for mounting the first set of brushes on the first side of the base plate; and
a second mounting plate for mounting the second set of brushes on the second side of the base plate, the first mounting plate and the second mounting plate being conductive.

3. The electric drive system of claim 1, wherein the controller is adapted to:
determine a first brush parameter for the first set of brushes, and a second brush parameter for the second set of brushes;
determine a difference between the first brush parameter and the second brush parameter; and
selectively command the polarity flip of the respective brush polarity when the difference is greater than a predefined threshold.

4. The electric drive system of claim 3, wherein the controller is adapted to:
obtain the first brush parameter and the second brush parameter via one or more models based in part on at least one of a revolutions per minute of the electric motor, actual rotor current and a rotor current rise rate; and
track the first brush parameter and the second brush parameter separately.

5. The electric drive system of claim 1, wherein the controller is adapted to command the polarity flip of the respective brush polarity when a threshold number of rotations are achieved at one polarity, and make a switch at a subsequent cycle.

6. The electric drive system of claim 1, wherein the controller is adapted to command the polarity flip of the respective brush polarity when a noise amplitude is above a threshold noise level, the noise amplitude based in part on sensor data.

7. The electric drive system of claim 1, wherein the controller is adapted to command the polarity flip of the respective brush polarity when a threshold number of vehicle key cycles are met.

8. The electric drive system of claim 1, wherein the controller is adapted to command the polarity flip of the respective brush polarity when the rotor assembly is at a zero speed and a vehicle brake is applied.

9. The electric drive system of claim 1, wherein the controller is adapted to selectively offset a stator current control angle of the electric motor based on the respective brush polarity, the stator current control angle being offset by a factor of 360 degrees divided by a number of poles in the rotor assembly.

10. The electric drive system of claim 1, wherein the controller is adapted to:
selectively apply a respective brush break-in mode during an initialization period, the respective brush break-in mode permitting the first set of brushes and the second set of brushes to experience positive polarity at a plurality of rotor current levels; and
exit the respective brush break-in mode when at least one exit condition is met.

11. The electric drive system of claim 10, wherein the respective brush break-in mode includes a first brush break-in mode, the controller being adapted to:
apply the first brush break-in mode in a direct current (DC) mode with torque generation, including maintaining a zero alternating current (AC) rotor current, maintaining a non-zero stator current and varying a DC rotor current based in part on torque demand.

12. The electric drive system of claim 10, wherein the respective brush break-in mode includes a second brush break-in mode, the controller being adapted to:
apply the second brush break-in mode in a DC mode without torque generation, including maintaining a zero AC rotor current, maintaining a zero stator current, and maintaining a DC rotor current at a relatively constant absolute value.

13. The electric drive system of claim 10, wherein the respective brush break-in mode includes a third brush break-in mode, the controller being adapted to:
apply the third brush break-in mode with torque generation, including maintaining a baseline DC rotor current, maintaining a non-zero stator current, and maintaining an AC rotor current at a relatively constant value;
selectively vary an AC frequency of the AC rotor current; and
control a power input to the electric motor such that a peak-to-peak value of the AC rotor current is greater than twice the baseline DC rotor current.

14. The electric drive system of claim 10, wherein the respective brush break-in mode includes a fourth brush break-in mode, the controller being adapted to:
apply the fourth brush break-in mode without torque generation, including maintaining a zero DC rotor current, maintaining a zero stator current, and maintaining an AC rotor current with a relatively constant peak-to-peak value.

15. The electric drive system of claim 10, wherein the respective brush break-in mode includes a fifth brush break-in mode, the controller being adapted to:
apply the fifth brush break-in mode without torque generation, including maintaining a zero DC rotor current, maintaining a zero stator current; and
selectively vary an AC frequency of the AC rotor current;
direct a thermal-limiting pattern for an AC rotor current such that a peak-to-peak value of the AC rotor current decreases over time when thermal limits are approached.

16. The electric drive system of claim 10, wherein the respective brush break-in mode includes a sixth brush break-in mode, the controller being adapted to:
apply the sixth brush break-in mode without torque generation, including maintaining a zero DC rotor current, maintaining a zero stator current, and directing a pulsed current pattern for an AC rotor current.

17. A vehicle comprising:
an electric motor having a stator assembly, and a rotor assembly with a rotor shaft;
a base plate, a first slip ring and a second slip ring operatively connected to an outer side of the rotor shaft, the first slip ring and the second slip ring being rotatable relative to a longitudinal axis of the rotor shaft;
a first set of brushes mounted on a first side of the base plate, the first set of brushes being adapted to establish an electrical connection with the rotor assembly through contact with the first slip ring;
a second set of brushes mounted on a second side of the base plate, the second set of brushes being adapted to establish the electrical connection with the rotor assembly through contact with the second slip ring; and
a controller having a processor and tangible, non-transitory memory on which instructions are recorded, the controller being adapted to selectively apply a respective brush break-in mode during an initialization period; and
wherein the controller is adapted to exit the respective brush break-in mode when at least one exit condition is met, the brush break-in mode permitting the first set of brushes and the second set of brushes to experience positive polarity at various rotor current levels.

18. The vehicle of claim 17, wherein the respective brush break-in mode includes a first brush break-in mode, the controller being adapted to:
apply the first brush break-in mode in a direct current (DC) mode with torque generation, including maintaining a zero alternating current (AC) rotor current, maintaining a non-zero stator current and varying a DC rotor current based in part on torque demand.

19. The vehicle of claim 18, wherein the respective brush break-in mode includes a second brush break-in mode, the controller being adapted to:
apply the second brush break-in mode in a DC mode without torque generation, including maintaining a zero AC rotor current, maintaining a zero stator current, and maintaining a DC rotor current at a constant value.

20. A vehicle comprising:
an electric motor having a stator assembly, and a rotor assembly with a rotor shaft;
a base plate, a first slip ring and a second slip ring operatively connected to an outer side of the rotor shaft, the first slip ring and the second slip ring being rotatable relative to a longitudinal axis of the rotor shaft;
a first set of brushes mounted on a first side of the base plate, the first set of brushes being adapted to establish an electrical connection with the rotor assembly through contact with the first slip ring;
a second set of brushes mounted on a second side of the base plate, the second set of brushes being adapted to establish the electrical connection with the rotor assembly through contact with the second slip ring; and
a controller having a processor and tangible, non-transitory memory on which instructions are recorded, the controller being adapted to selectively apply a respective brush break-in mode during an initialization period;
wherein the controller is adapted to exit the respective brush break-in mode when at least one exit condition is met, the respective brush break-in mode permitting the first set of brushes and the second set of brushes to experience positive polarity at various rotor current levels;
wherein the controller is adapted to apply the respective brush break-in mode with torque generation, including maintaining a baseline DC rotor current, maintaining a non-zero stator current, and maintaining an AC rotor current at a relatively constant value; and
control a power input to the electric motor such that a peak-to-peak value of the AC rotor current is greater than twice the baseline DC rotor current.
